(19) United States
(12) Patent Application Publication
(10) Pub. No.: US 2007/0067234 A1
(43) Pub. Date: Mar. 22, 2007

(54) Mortgage loan system and method

(76) Inventor: James J. Beech, Sandy, UT (US)

Correspondence Address: THORPE NORTH & WESTERN, LLP., 8180 SOUTH 700 EAST, SUITE 200, SANDY, UT, 84070, US

(21) Appl. No.: 11/232,826

(22) Filed: Sep. 21, 2005

(51) Int. Cl. G06Q 40/00

(52) U.S. Cl. 705/38

(57) ABSTRACT

A system and method are provided for qualifying and selecting mortgage loans for a borrower. The method includes the operation of collecting mortgage loan information from the borrower. A further operation is obtaining credit information for the borrower via a network based on the mortgage loan information. The combined mortgage loan information and credit information can be compared with the conditions of a plurality of mortgage loan programs offered by a mortgage supplier. The comparison can generate a qualified active listing of mortgage loan programs from a plurality of mortgage loan programs. The qualified active listing includes mortgage loan programs for which a borrower has been approved. Another operation is selecting a mortgage loan program that a borrower desires to purchase.

### BACKGROUND

The mortgage industry has changed greatly in the last 15 years. One significant change has come from technology. Automation advances have shifted away from hard-copy documents toward electronic closings and document preparation. Even fax machines are being used less and less.

Technology drives other changes and tends to provide easy ways to update loan rates and download documents. The Internet is still an emerging technology but networked software has become more prevalent. New loan products are proliferating and loan rates may change daily or even during the day.

Another side effect of technology use is the general increase in information available on borrowers, properties, geographical areas, and the performance of different types of loans. This information makes it easier for lenders to “score” the loans submitted, and price the loans based on risk.

There have also been significant changes in the source of loan originations. Until the early to mid-1990s most mortgage loans were originated directly by banks, Savings & Loans, Mutual Savings Banks, and mortgage companies. With the increasing use of technology and the previous failure of many Savings & Loans companies, mortgage brokers began to grow in importance. The number of brokers has increased over 500% since the late 1980s and the growth in this industry is expected to continue.

One reason for this growth is service. Banks and their related competitors have generally been poorer at service than smaller, more locally-oriented enterprises. As borrowers have become more informed and as the products have become more complex and numerous, borrowers seek more direct and less biased advisors. The local mortgage brokers most often fill this role. In addition, the Internet appears to be unlikely to supplant this direct contact relationship. While there will always be some borrowers who do not need face-to-face contact, there is nothing to indicate that the majority of borrowers will move exclusively to a faceless Internet for their mortgages.

Mortgage-backed securities are a large part of the financing back-bone of the industry. Since 1990, approximately 60% of loans originated for 1-4 family homes have been packaged and resold by major correspondent lenders or retail lenders as bonds, and these bonds are known in the industry as mortgage-backed securities. This provides a relatively fast replacement of warehouse lines and/or lending company assets, and can allow the lenders to continue lending without raising additional capital. Despite some fallout in 2000 and 2001 due to pricing problems on non-conforming loans of lower credit quality and higher risk, the trend toward securitizing home mortgages appears to be continuing.

FIG. 1 illustrates a general overview of the current mortgage industry. The following background discussion will discuss elements in the mortgage industry as illustrated generally in the figure.

Banks and other traditional retail lenders 100 are some of the major players in the mortgage market. Wells Fargo and Washington Mutual are the two largest traditional retail lenders, partially due to a run of substantial acquisitions over the last decade. They offer store-front/traditional bank lending office contacts, accept applications from mortgage brokers, and correspond with mortgage companies as well as with other mortgage bankers. Their depository base gives them advantage in the market as they are able to fund loans without major warehouse line support.

Mortgage bankers 140 are companies that act as originators and often function in both retail and wholesale areas. Many companies in this segment of the market tend to be local or regional at their largest. However, Countrywide is a large player in this segment and there are others with a national presence. Because these companies often have multiple branches they can provide strong competition in national as well as in specific, narrow markets.

Mortgage broker companies 110 only originate loans. They do not close and fund the loans themselves, passing that responsibility off to either traditional banks or mortgage banks. There are approximately 44,000 brokers in the U.S. today and they originate roughly 65% of all current mortgages. They are a growing force often due to their small, local nature. They can provide hands-on service and an increasing variety of choices for the increasingly demanding consumer. Some brokers are subsidiaries or affiliates of major lenders, such as Ditech which is a part of GMAC. However, most brokers are independent and are always looking for better service from mortgage banking institutions, faster turn-around, and reliable quality of processing and documentation.

Correspondent Lenders 120 are the companies that buy most of the loans in the marketplace and often are the major conduits to securitization 130 (the packaging of loans for the secondary bond market). Like many other mortgage industry participants, these companies often wear many hats. Banks and mortgage bankers like Wells Fargo and Countrywide are correspondents. Moreover, the large “government” correspondent lenders such as FNMA (Fannie Mae) and FHLMC (Freddie Mac) are major factors, basically establishing the current rates for most conventional mortgage products. These companies, as seen by those identified above, are retail, wholesale, and even broker companies.

The Mortgage Bankers Association of America provides the data in the following table including recent history and forecasts of activity in mortgage lending. The historical 2003 spike in the market caused by low-rate refinancing will not be duplicated any time soon. However, the underlying mortgage company growth and opportunities still appear to exist in the market.

| | 2000 | 2001 | 2002 | 2003 | 2004 | 2005 |
|---|---|---|---|---|---|---|
| SELECTED INDUSTRY DATA* | (Actual) | (Actual) | (Actual) | (Actual) | (Preliminary) | (Forecast) |
| HOUSING MEASURES (000) | | | | | | |
| Housing Starts | 1,603 | 1,601 | 1,705 | 1,848 | 1,949 | 1,853 |
| Home Sales | 10,563 | 6,204 | 6,539 | 7,189 | 7,802 | 7,256 |
| INTEREST RATES (%) | | | | | | |
| 30-Year Fixed | 8.04 | 6.93 | 6.43 | 5.8 | 5.8 | 6.2 |
| 10-Year Treasury Yield (T-Bill) | 6.0 | 5.0 | 4.6 | 4.0 | 4.2 | 4.5 |
| MORTGAGE ORIGINATIONS ($BILLIONS) | | | | | | |
| Total 1- to 4-Family | 1,139 | 2,243 | 2,852 | 3,810 | 2,852 | 2,542 |

*Data is found at www.mbaa.org

Increasingly competition is about service, automation, accuracy and speed. Enlarged regulation and tightening of disclosure laws has actually tended to level the playing field in regard to shortening document packages or cutting corners in underwriting. Secondary market and securitization requirements lead to another leveling influence, again driving the same competitive factors.

Competition cannot indefinitely be based on rates alone, because cutting rates invariably leads to problems with financial performance for a company. Cutting rates and locking them with borrowers at rate levels that are lower than the secondary market has generally been competitively unworkable (so-called hedging in the mortgage rate arena) and has usually met with disastrous results. The final measurements of competitive superiority are based on total origination/funding volume and the company's profitability and valuation.

Competition has helped to drive some of the conversion of the mortgage industry to electronic communication, data transfer and data storage. Some electronic loan origination and processing systems are available for use today. Examples of such products are Calyx Point, Contour, and Mortgage Ware. These systems provide some basic mortgage origination and processing. They are built for single loan approval, where the mortgage loan officer originates the loan business and is generally experienced enough to choose an available loan program for the loan customers. Because of the expertise used and because the loan officer generates the business, mortgage companies are typically in the position of pleading with loan officers to generate business and remain working for them.

Mortgage lending companies and mortgage brokers suffer from similar problems. As loan products become more complex and disclosure becomes increasingly tedious, turnover and subsequent training become significant problems. Turnover can be very high in the mortgage industry. In a current traditional mortgage company, the learning curve to be effective in a mortgage setting is relatively long. This is true because the business language is complex, detailed, and often misunderstood. Furthermore, employees must have enormous experience with many different software systems. This complexity results in an inconsistent level of loan underwriting. In fact, multiple processing of a similar loan can provide different underwriting results. Due to these complexity factors, recruiting and training loan officers, processors, and underwriters is expensive.

In addition to the complexity factors surrounding the mortgage industry, the complexity of the software can be overwhelming for mortgage professions. Currently, it can take up to eleven (11) software tools to close a single loan. A list of the software products that may be needed is listed here:
1. A contact management system (Outlook, Goldmine, and ACT)
2. A loan origination system (Point, Genesis, Contour, MortgageWare)
3. A credit reporting system (NACM, FAR WEST, and ERS)
4. A knowledge base system (AllRegs.com or LoanRegs.com)
5. Automated Underwriting Systems (like Direct Submit, Freddie Mac's LP.com, Fannie Mae's DU, and RFC's Assetwise)
6. Shopping loan service (LionInc.com or loanofficer.com)
7. Re-entry into loan origination system (Point, Genesis, Contour, DataTrac)
8. Mortgage Insurance ordering (RAPid Link, DirectAIM, or e-magic)
9. Title/Escrow ordering, Flood Certifications and Tax Service (Service Suite)
10. Closing Document system (DocMagic and Doc-u-Prep)
11. Closing statement and HUD-1 closing forms (HUDsoft and HUD Magic)
   The sheer magnitude of these legacy technologies can create additional expense and complexity for the mortgage industry. To make matters worse, most of the tools in use by conventional lenders are DOS-based or other legacy systems that are largely incompatible with one another.

The number of software tools currently used to process loans and the large amount of paper used from the software programs often results in ineffective communication between loan officers, processors, underwriters, and the end investors. There is also a lack of effective “corroboration” (i.e., authority, authentication, or validation) between the loan officers and borrowers because the paper trail can be difficult to follow and electronic tools are generally incompatible.

### SUMMARY

A system and method are provided for qualifying and selecting mortgage loans for a borrower. The method includes the operation of collecting mortgage loan information from the borrower. A further operation is obtaining credit information for the borrower via a network based on the mortgage loan information. The combined mortgage loan information and credit information can be compared with the conditions of a plurality of mortgage loan programs offered by a mortgage supplier. The comparison can generate a qualified active listing of mortgage loan programs from a plurality of mortgage loan programs. The qualified active listing includes mortgage loan programs for which a borrower has been approved. Another operation is selecting a mortgage loan program that a borrower desires to purchase.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, wherein:

FIG. 1 illustrates a general overview of the current mortgage industry;

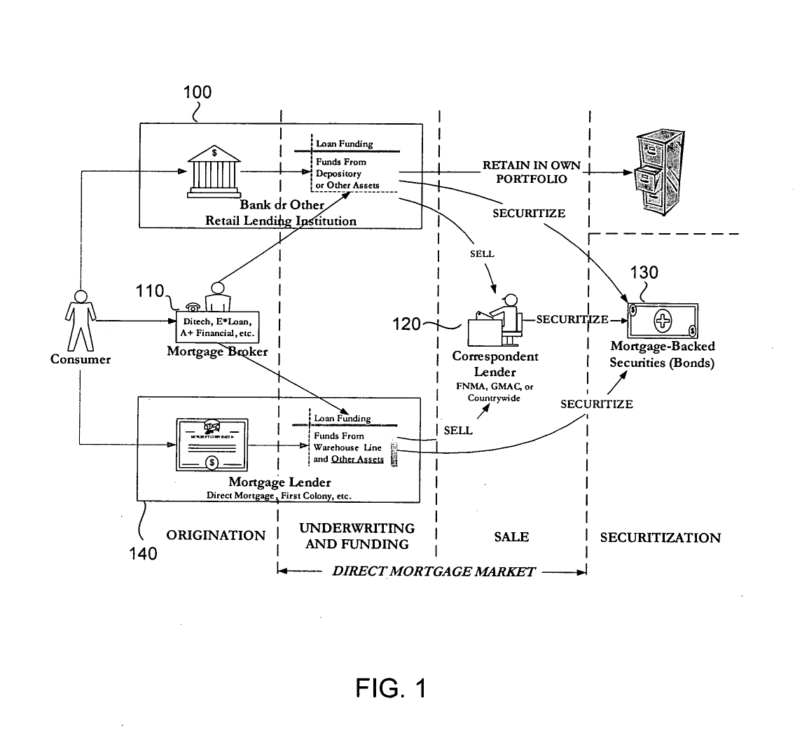

FIG. 2 illustrates the prior art method through which mortgage brokers receive mortgage loan approvals;

FIG. 3 is a flow chart illustrating one embodiment of a system and method for mortgage approval and selection;

FIG. 4 is a block diagram illustrating an embodiment of modules and dataflow for the mortgage management system;

FIG. 5 illustrates an embodiment of a display and user interface screen that includes a list of multiple approved loan programs;

FIG. 6 further illustrates loan programs that were not run against the borrower's information and referred loans;

FIG. 7 depicts a window detailing reasons the borrower has been rejected by specific loan programs based on the criteria for the loan program;

FIG. 8 illustrates a graphical interface for guiding a mortgage professional through the steps for originating, approving and closing a loan in an embodiment of the present mortgage software system;

FIG. 9 illustrates an example of an underwriting checklist with automatically generated checklist items;

FIG. 10 illustrates an example interface for entering a borrower's loan information;

FIG. 11 depicts an example of an electronic audit interface;

FIG. 12 illustrates an example of a loan program setup display screen;

FIG. 13 illustrates example criteria for a loan program with the category of trade lines and derogatory credit being visible;

FIG. 14 illustrates an example of loan program criteria for judgments and collections for the borrower;

FIG. 15 illustrates an example of a display screen where each mortgage broker can set their own interest rates that are based on the current day's interest rate pricing;

FIG. 16 depicts an embodiment of a final underwriting document checklist that has been electronically populated; and

FIG. 17 depicts an embodiment of a checklist display screen for completing the final documents.

### DETAILED DESCRIPTION

Reference will now be made to the exemplary embodiments, and specific language will be used herein to describe the same. It will nevertheless be understood that no limitation of the scope of the invention is thereby intended.

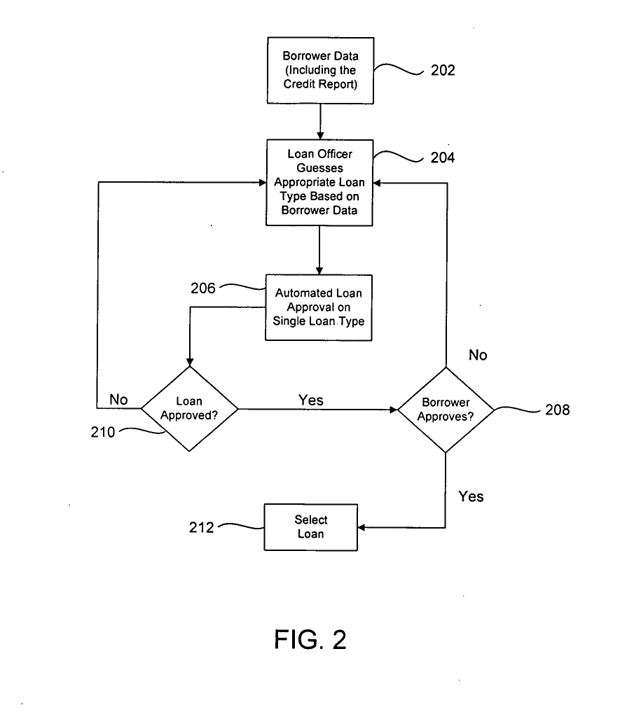

FIG. 2 illustrates one prior art method through a mortgage broker can receive one mortgage loan approval. This old approval method generally uses the large number of software packages discussed previously. Currently, a mortgage broker will use one stand alone software package to collect and store the borrower's data and then another separate software program to retrieve a credit report as in block 202. Once this information has been received from the borrower, then the mortgage loan officer guesses the appropriate loan type for the borrower based on the borrower data researched through a different software tool as in block 204. In other words, the loan officer will pick one loan that may work for the borrower based on the previous experience of the loan officer and the borrower's financial condition. In addition, the mortgage broker may receive some input from the borrower regarding the loan length and whether the borrower wants a fixed or variable interest rate.

The loan broker can then enter the borrower's information into stand alone loan approval software along with the individual loan the mortgage broker wants approved. Such currently known systems allow the mortgage broker to enter a single loan type and then receive an approval or disapproval for the single loan offering from the mortgage lending institution as in block 206. If the mortgage lender approves the loan for the borrower as in block 210, then the mortgage broker will present the approved loan to the borrower as in block 208. If the borrower approves the loan then the loan may be selected for completion of the underwriting conditions as in block 212.

In the situation of FIG. 2 where a more sophisticated borrower rejects the approved loan in block 208, then the mortgage broker will enter another single loan program into the loan approval software and try to obtain another loan approval on a different loan product.

This entire cycle of obtaining approval for a single submitted loan may also be repeated when-the loan is not approved by the mortgage banking institution as shown in block 210. In such a situation, the mortgage broker can select another loan that might conform to the borrower's credit history and financial desires. This approval process may take several long iterations until the appropriate loan is selected and then approved. Moreover, the iterative selection and approval process can waste a significant amount of energy for the mortgage broker and may be difficult for the mortgage broker to use. In the end, the borrowers are not necessarily likely to get the most effective product for their needs because the broker simply guesses which loan program might meet the borrower's needs.

Unfortunately, many mortgage brokers give the borrower little choice in accepting or rejecting the loan because most mortgage brokers receive input from the borrower and then select what loan package they believe will be best for the borrower. In addition, most mortgage brokers do not offer multiple loan package options to the borrower. When the loan length and interest rate structure match the borrower's basic criteria then the mortgage broker is likely to simply proceed and complete the underwriting of the loan. This is particularly true with most borrowers who are not sophisticated enough to realize that there are a large number of loan offering available to them.

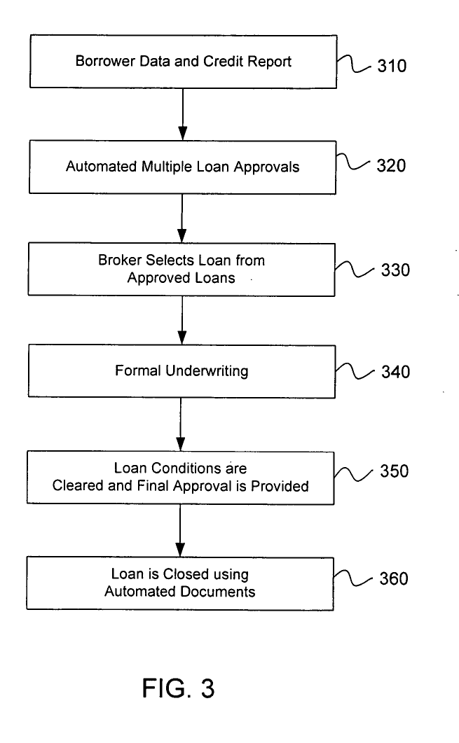

FIG. 3 is a flow chart illustrating one embodiment of a system and method for mortgage selection and approval. In this method, mortgage loan information is collected from the borrower and recorded by a mortgage software system in its accompanying database. The mortgage loan information can include a borrower's name, social security information, address of the real estate purchase, financial data, employment information, residence information, and similar information. In addition, a credit report may be obtained electronically over a computer network from a credit reporting agency as in block 310. This credit report information may be stored in the database along with the credit report and borrower's information or in some other electronically accessible location.

The borrower's mortgage loan and credit information are then compared to a plurality of mortgage loan programs available in the mortgage loan system's database. This comparison results in automated multiple loan approvals as in block 320. There are also other data elements that may be helpful in completing the automated loan approval process such as information about the property to be purchased and the like.

As a result of the automated loan approval step, a qualified active listing of approved mortgage loan programs for the borrower can be generated and displayed to the borrower and/or mortgage broker. The qualified active listing of approved mortgage loans generally includes a listing of mortgage loan programs for which a borrower conforms to the mortgage loan criteria and/or thresholds. These active mortgage loan programs are current programs that are actually available to the borrower and the borrower has been approved for the loan program. The approval may be performed by an underwriting software engine or a similar logic rule process that performs the comparisons.

In the past, mortgage approval software simply returned an approval for one mortgage that was being submitted by a mortgage broker. In contrast, the present embodiment presents a listing of multiple approved loans that the borrower may select. Note that in the prior method of providing loan approval, the loan selection by a mortgage broker occurred first followed by a single approval. The problem with this approach is that the mortgage broker has already set his mind on a specific loan program without even knowing whether there is a possibility of approval for the loan. Whereas the present mortgage software first provides approval on multiple loan programs and then allows for the selection of the desired loan program after the approvals have been received. This is the opposite of what has been done in the past and the many benefits of this method and system will be later described in further detail.

The qualified active listing of mortgage loan programs can also be generated using loan approval conditions that include the maximum loan/minimum appraisal, specific loan amount/minimum appraisal, a user defined purchase price and loan amount, a selected loan program and advanced approval. The loan conditions used to identify a qualified active listing may change periodically as investor requirements and government regulations change.

Another particularly surprising result is that multiple loan programs can be approved with a single click or single user interface action by the user of the software system. This is in contrast to prior systems where just one loan at a time can be approved. The single action interface can also be used to select the desired loan and initiate loan underwriting.

Referring again to FIG. 3, this listing of approved mortgages can be presented to the broker (or possibly the borrower) for approval through a graphical user interface on a computing device or client computer. Next, the broker can select a mortgage loan program that the borrower desires to purchase from the list of already approved loans as in block 330. Once the desired loan program has been selected, the conditions for the mortgage underwriting checklist are electronically populated for that specific loan package and formal underwriting takes place as in block 340. At this stage of the process, the underwriter can also enter additional conditions manually. The mortgage broker can then provide information to satisfy conditions. Next, the loan conditions can be cleared and can be annotated as cleared in the mortgage loan system based on the information provided as in block 350. When all the loan conditions are cleared, then the final approval can be provided from the mortgage banker. The clearing of the conditions step can include the automated production of an electronic mortgage underwriting checklist populated with criteria corresponding to the selected mortgage loan program. The checklist can then be used by a human underwriter.

Closing documents and most other checklist items may also be generated using automatically filled fields in the documents as in block 360. In certain embodiments, the closing documents can be entirely electronically generated. In a different embodiment, some area of the electronically filled documents can include manually entered data such as addresses, details not known at document generation time, etc. The mortgage system can store the data needed to generate a live set of closing documents at any time. In other words, the software system user, mortgage broker, or mortgage banker can view, print, and/or update all printed forms at any time from any location with a network or internet connection to the present mortgage software system. Any documents that are not electronically generated using the mortgage loan management software can be scanned into the system and stored for later use. For example, some documents such as consumer loans or employee agreements can be scanned in for later use or re-printing.

Several benefits result from providing a listing of approved mortgages to the borrowers, mortgage brokers, or other users of the mortgage software system. One of these benefits is that borrower's have more choices in the mortgage program that is finally selected and are not simply at the mercy of a loan program that is promoted or selected by the mortgage broker.

The mortgage broker can also provide a wider range of products and services to the borrowers. A wider range of products allows the mortgage broker to be more competitive. Not only do the borrowers benefit by receiving multiple loan product approvals but wholesale mortgage institutions can benefit because multiple loan approval enables mortgage brokers to promote a wider variety of products from the wholesale and mortgage banking institutions that might meet the borrower's needs. So those mortgage bankers or institutions with the most attractive loan package can sell more of those loans.

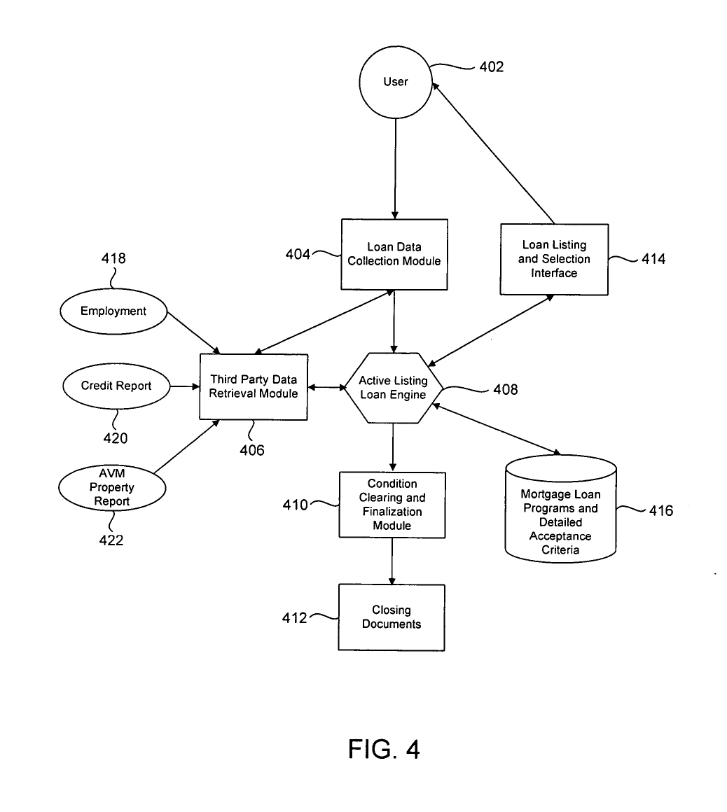

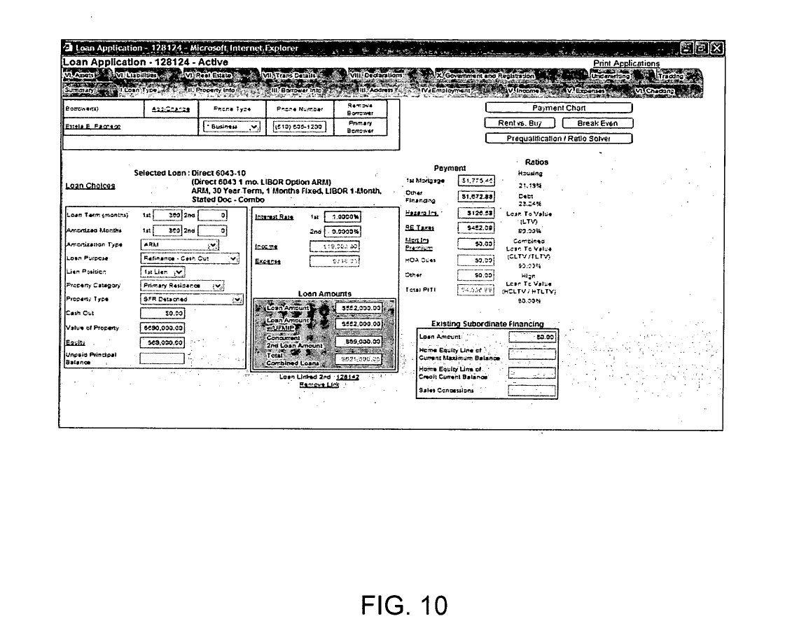

Now that one example of the present system and method for mortgage software has been provided, a more detailed discussion of an additional embodiment will be described. FIG. 4 is a block diagram illustrating modules and their related dataflow for the mortgage management system. When accessing the system, a user 402 can input relevant mortgage data into the loan data collection module 404. For example, the borrower, mortgage broker, loan processor or other data entry personnel may enter information about the borrower and the property that is desired to be purchased. FIG. 10 illustrates an example interface for entering a borrower's loan information including the property profile, employment, expenses, debts, assets and other borrower related information. Returning to FIG. 4, the data collected from the borrower can be supplied to an active listing loan engine 408. The loan data may include the borrower's name, social security number, current residence address, place of employment, and similar information.

A third party data retrieval module 406 may also be in electronic communication with the active listing loan engine 408. When the borrower's data is received from the loan data collection module 404, the active listing loan engine can request that the third party data retrieval module request and load the third party data. The third party retrieval module can request data from third party data reporting agencies via the Internet, a wireless network, or a proprietary network. For example, an electronic credit report 420 can be requested from one of the widely known credit reporting agencies. In addition, the third party data that is requested may include an electronic verification of employment 418. An AVM (automated value model) property report can also be requested about the property being purchased to supply third party information 422 about the purchase property in order to avoid fraud. Other third party information can be requested as available, such as electronic property tax records, electronic title records, value comparisons, and the like.

The borrower information combined with the retrieved third party information may be used to approve two or more mortgage loan programs for the borrower. In other words, the third party information and the borrower information may be loaded into the active listing loan engine 308 and then compared to two or more mortgage loan programs offered by a mortgage supplier or mortgage bank. For example, tens or hundreds of loan programs may be stored in a database and then the borrower's information may be compared to all or a subset of the possible loan programs that are available. The user or mortgage broker may also filter the loan programs that are compared to the borrower's information or profile. As a result, the borrower's information may selectively be compared to fixed interest loans or loan programs with specific property criteria.

The mortgage loan programs and detailed acceptance criteria can be stored in a centralized mortgage loan program database 416 that is in communication with the active loan listing engine. The mortgage loan database may be a local database or the database may be a large distributed database that is divided between many network servers or physical locations. The borrower's loan information and related loan information may be stored in the same database 416 or in different databases on different servers.

The loan products provided in the mortgage approval software system and database may be based on the current products (rates, pricing, and underwriting criteria) of correspondent lenders. Alternatively, a wholesale mortgage bank or retail mortgage bank with the appropriate resource can develop, support financially, and manage its own loan products in addition to working with correspondent lenders. Many mortgage banks, including some that are quite large, operate with a diversity of loan programs from many financial sources.

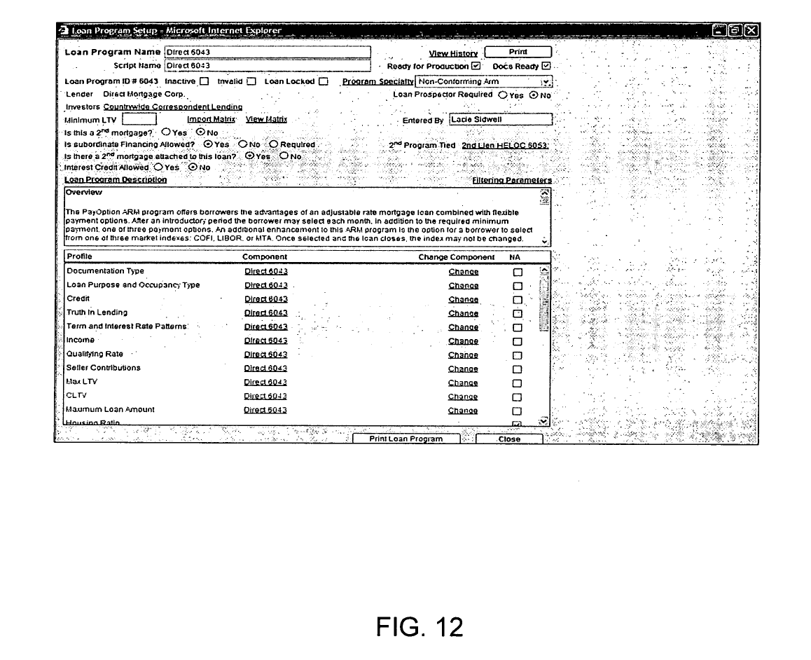

FIG. 12 illustrates an example of a loan program setup window. This loan program setup window allows a mortgage professional or mortgage bank to enter a mortgage loan program into the mortgage software system. In addition, the mortgage loan programs can be modified as the loan programs change.

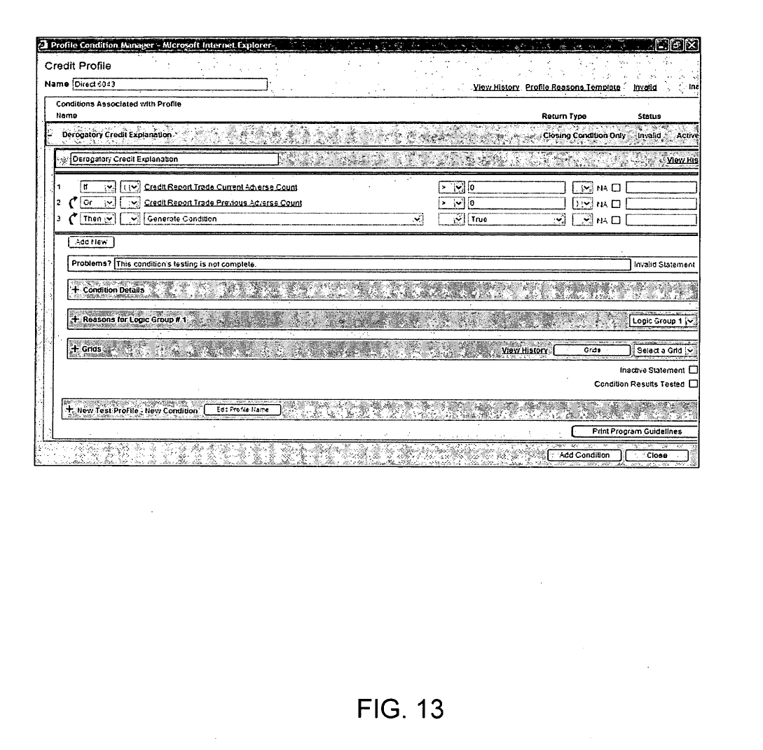

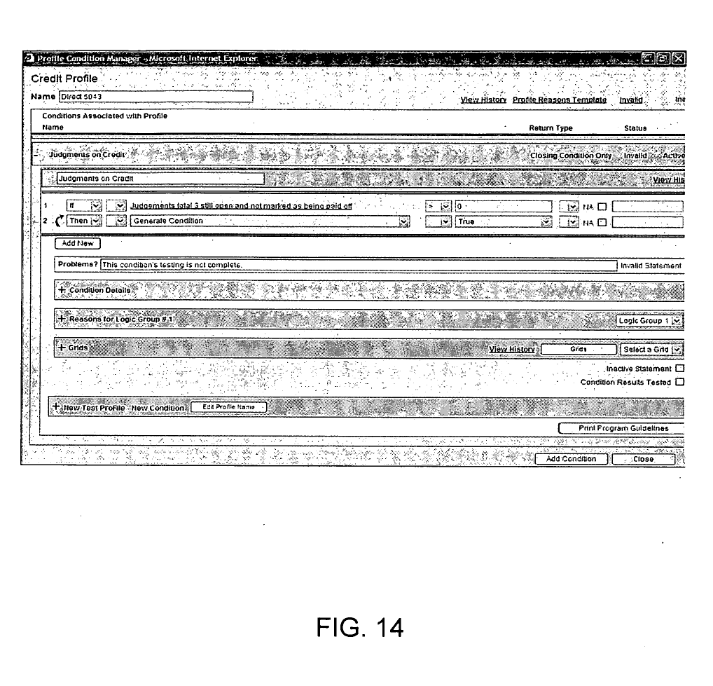

FIG. 13 illustrates some example criteria for a mortgage loan program with the category of derogatory credit being visible. FIG. 14 illustrates an example of an interface screen for the loan program criteria regarding judgments for the borrower. Other additional criteria for the mortgage program can be included such as collections, trade lines, late consumer debt, late installment debt, late mortgage payments, bankruptcy and repossessions, and similar loan program criteria. An unlimited number of criteria can be used to define a loan product. An end user of the program such as a mortgage banker can make changes and additions to the criteria in a straight-forward and speedy manner. Such immediate updates allow the loan products to be updated frequently or as soon as the loan products change. As soon as a loan program changes, then the underwriters will immediately be using those changes for underwriting all the new loans for that program.

In FIG. 4, a loan listing and selection interface 414 can display the two or more approved loans that are supplied by the active listing loan engine. For example, 5 or 10 approved loans may be displayed to the user (e.g., borrower or mortgage broker) in a listing format such as a table, tabbed window, graphic display format, or similar interface view.

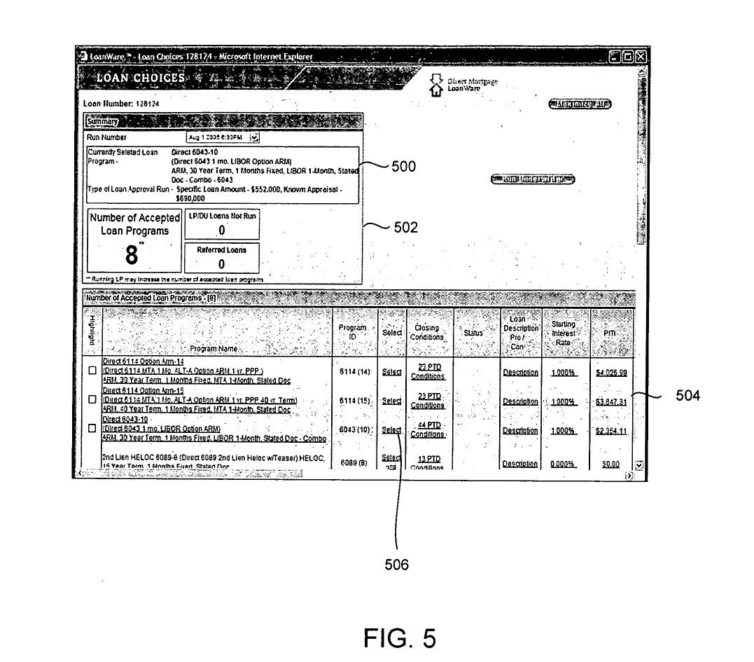

FIG. 5 illustrates an embodiment of a display and user interface display screen that includes a list of multiple loan programs run through the approval process. The approval process may compare the loan programs against the borrower's detailed information, credit history, real estate property and desired loan amount.

Toward the top of the display screen in FIG. 5 is a summary that includes the desired loan amount and the currently selected loan program 500 if a program has already been selected. A numerical summary 502 is also provided that displays the number of accepted loan programs, the number of referred loans (or rejected loans), and the number of loans that were not run or compared against the borrower information for approval.

Below the summary listing is a detailed listing of accepted loan programs 504. The detailed listings of accepted loan programs may include loan program information such as the program name, program ID, interest rate and other similar information. Each of the detailed listing categories may allow the user of the software system to drill down further and receive more information about the item in the category. For example, the “detailed description” item of a particular loan program can be selected to provide a detailed listing of the loan program criteria.

The user may be provided with an interface control 506 that allows the user to select the loan listing the borrower desires to purchase. For example, a check box, hyperlink, hot area, graphical button or similar user control can be provided for the user to select the desired loan. This selection may then link the borrower's profile and information to the desired mortgage loan program.

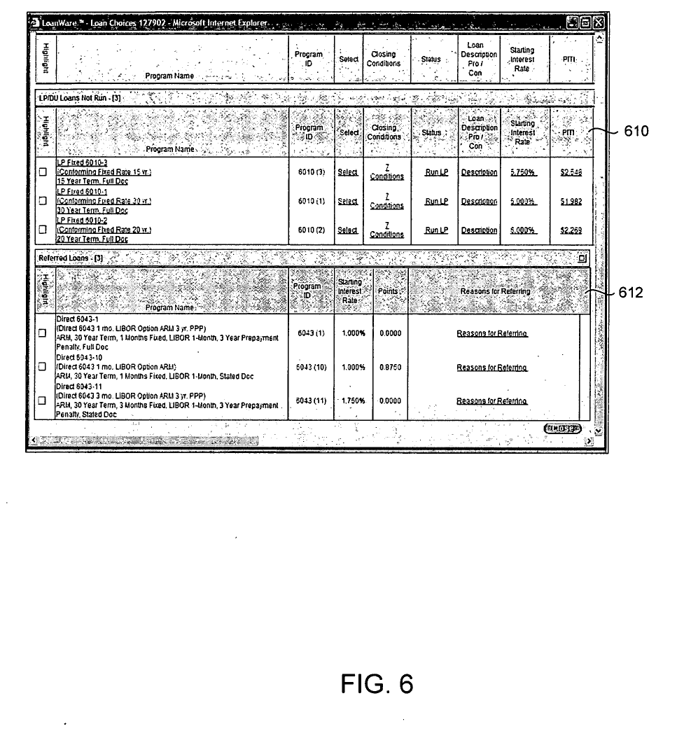

FIG. 6 further illustrates loan programs that were not run 610 against the borrower's information which may be displayed under a separate heading. These are for the reference of the borrower and mortgage broker as a comparison for which programs were excluded from the approval process.

Referred loan listings 612 and a related heading can also be provided. This grouping includes loans that were compared with the borrower's information but were not approved for specific reasons. The loan program listings under the referred heading can include loan program details and access to a user interface or window to view the reasons why the loan program was declined for the current borrower.

These referred loans may be ranked in an order based on loans that have the fewest rejected criteria down to the loans having the most rejected loan program criteria. However, the loan listings under any of the headings discussed do not need to have any specific ordering or ranking. Alternatively, the checklist can rank the referred loan based on the monthly payment amount, interest rate, and similar criteria.

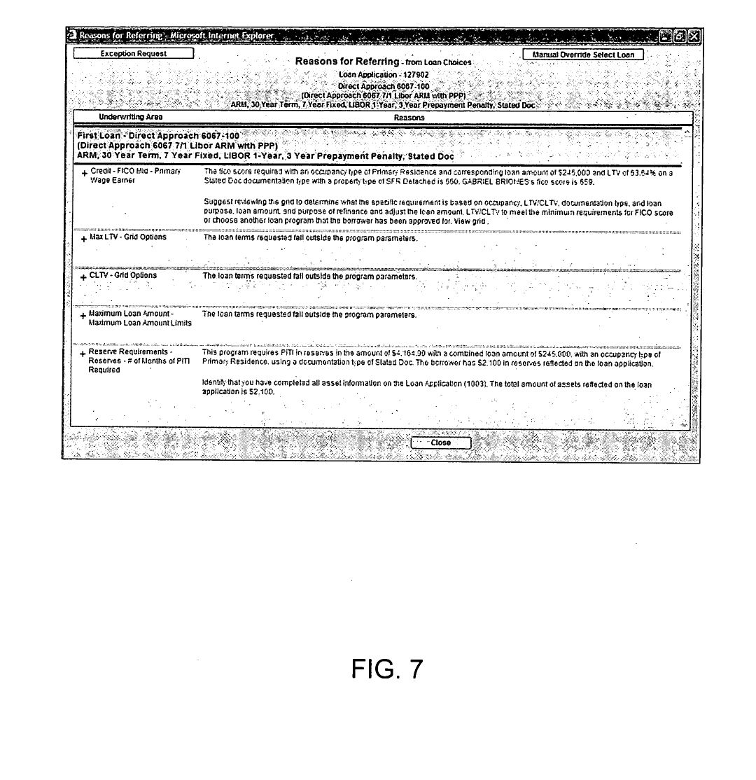

FIG. 7 illustrates a window detailing reasons why the borrower has been rejected for the specific loan program based on the loan program criteria. Such detailed rejections are valuable if a borrower would like to qualify for a certain type of loan. The rejection criteria can provide information on how the borrower can change their financial status or property purchase to qualify for the desired loan program.

Immediate approval of multiple loans allows the borrower or property buyer to decide which loan they would like to purchase based on actual underwritten loans and not just on a pre-qualification or pre-approval. This is in contrast to the common use of the term “pre-approved” which only means that a potential customer has passed a preliminary credit-information screening. A credit or finance company can reject the customers it invited with “pre-approved” loans if the financier does not like the applicant's credit rating. In contrast, the present system and method allow a user to pick a loan that is fully approved and that the mortgage lender agrees to supply to the borrower. For example, a borrower can decide which approved loan product to purchase in light of documentation and closing conditions needed. This allows the borrower to select an approved loan program that most meets their needs and one the borrower will be able to satisfy the mortgage conditions on appropriately.

After the loan program has been selected for a borrower, then the loan condition completion and underwriting phase can begin. A loan condition clearing and finalization module 410 are also provided to enable formal underwriting to take place in a uniform and rapid manner.

The loan checklist conditions are stored in a database. Database storage of the loan conditions to be cleared allows the conditions to be electronically loaded into a checklist for the underwriter. This means that an underwriter can have the same checklist for a given version of a mortgage loan program each time the loan is underwritten.

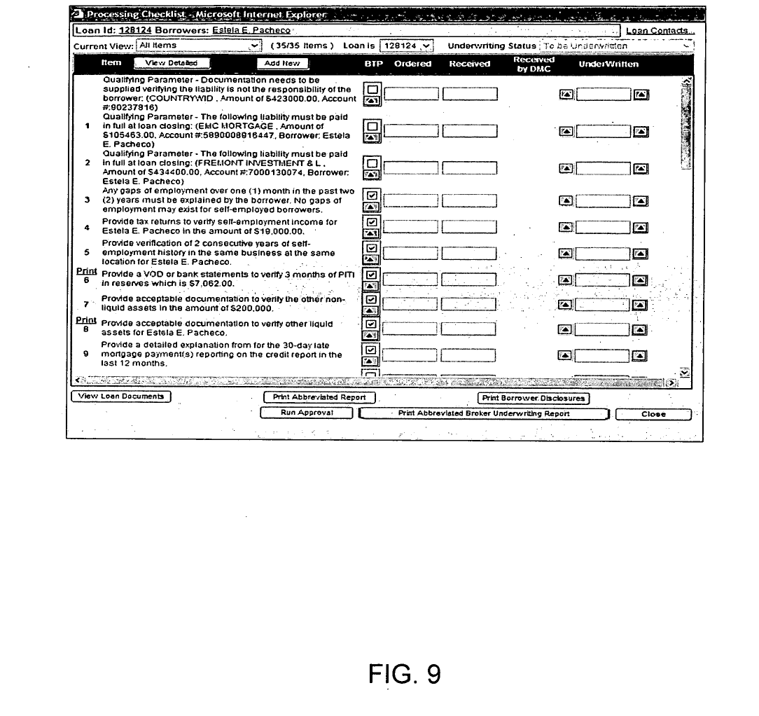

The underwriting checklist may be locked so that the questions set by the loan program developer cannot be changed. This allows the same current underwriting questions to be asked each time the same version of a mortgage loan program is underwritten regardless of which human underwriter is performing the underwriting. Even if a loan program changes, the underwriting questions can be updated and these changes are automatically used the next time underwriting takes place. Since the questions are automatically populated into the checklist, this requires less training for the underwriters because the underwriters do not have to generate their own underwriting questions and checklists. FIG. 9 illustrates an example of a graphical underwriting checklist with automatically generated checklist items.

Another benefit of using a consistent automated underwriting checklist is the uniformity provided for the loans underwritten using the described method and system. Since correspondent lenders dictate the loan products and buy the loans, conforming to their programs is virtually mandatory. Those mortgage lenders who stray from the correspondents' designated loan programs do not long survive. The present system and method helps mortgage professional conform to correspondents' mortgage products through the software system's database and the active loan listing engine. Failure to comply the correspondents' loan conditions may mean that an intermediate mortgage lender has no buyers for its loan portfolio. In such a situation, a mortgage lender might face the prospect of having to pay down warehouse lines from its own funds. Warehouse lines are provided by intermediary lenders who provide revolving lines-of-credit that mortgage bankers use to temporarily fund loans at closing.

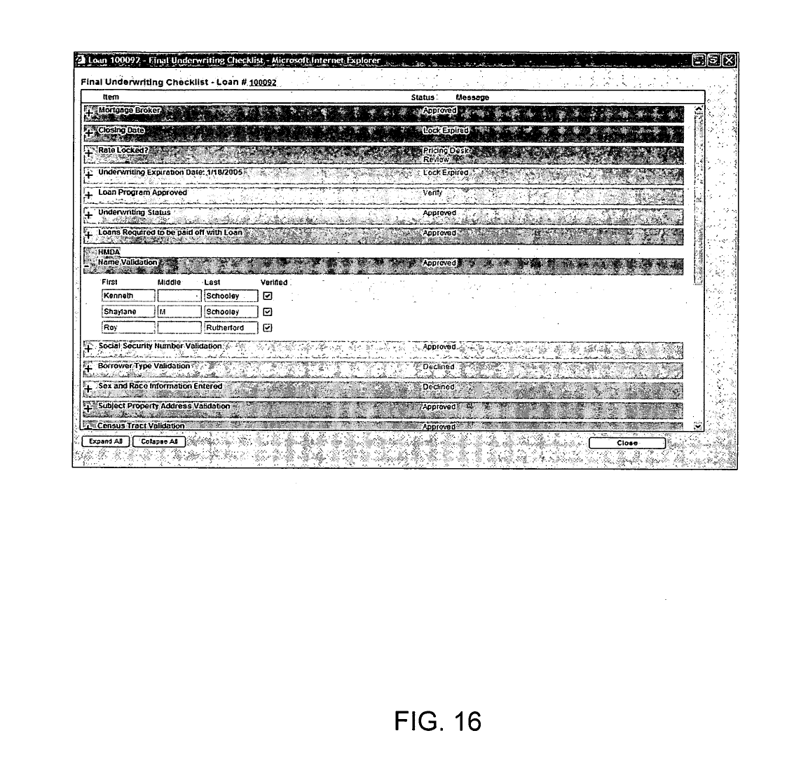

Referring again to FIG. 4, closing documents can also be generated after underwriting takes place using a closing document module 412. FIG. 16 depicts an embodiment of a final underwriting checklist that has been electronically populated. This check list shows what items have been completed and which items need further verification. The items in the underwriting checklist are pre-determined by the system based on the loan program being used for the mortgage. The pre-determined underwriting checklists and underwriting conditions provide a greater uniformity in underwriting.

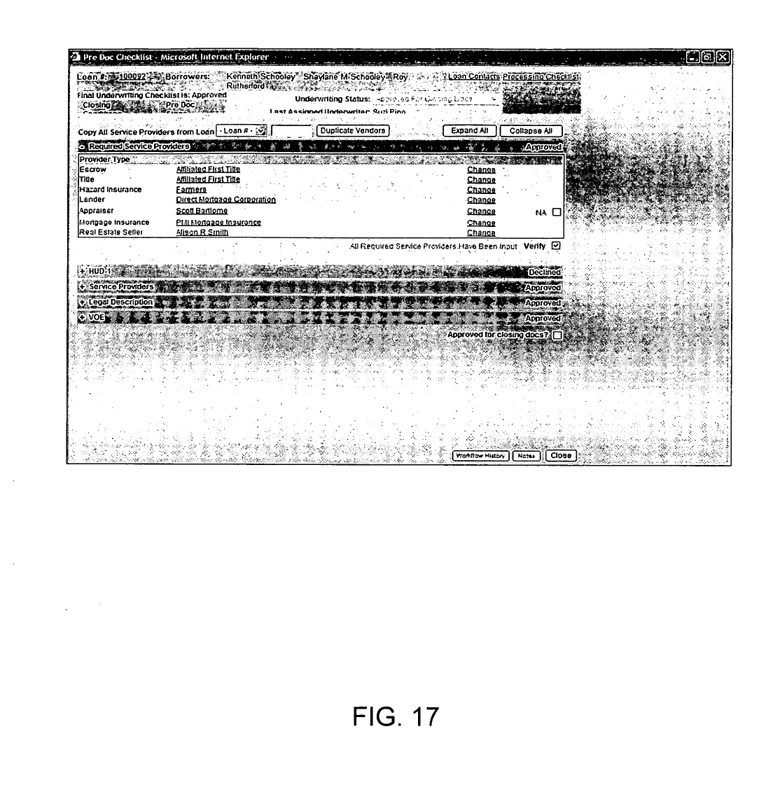

FIG. 17 depicts an embodiment of a checklist screen for completing the final documents. Once the final mortgage data has been checked then closing documents can be printed from the system. These closing documents will include electronically generated documents that are created based on the loan program being used and the current loan information.

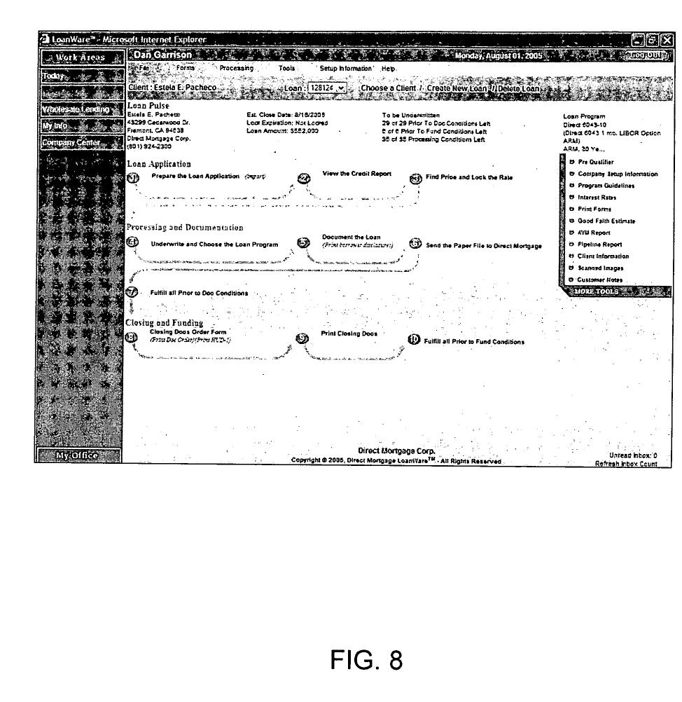

FIG. 8 illustrates a guided graphical interface for following the steps for originating, approving and closing a loan using an embodiment of the present mortgage software system. Particularly, the flow chart illustrates that the software system can allow an electronic mortgage application to be filled out by a user, a mortgage broker, loan office, or the borrower. This is step 1 in FIG. 8. Once the borrower's information is received then a credit report can be retrieved as in step 2 of FIG. 8. Other information may also be retrieved as discussed previously.

The borrower's application and credit information may be compared to the loan programs stored in the system. Then the approved loan programs and rejected programs can be displayed to the user as part of step 3 in the flowchart of FIG. 8.

Once the borrower has selected the loan program, then the mortgage loan will be documented in step 4. Next, the interest rate will be locked in step 5 and a paper file may be sent to the mortgage bank or institution in step 6. The loan conditions will be fulfilled by a loan processor and underwriter in step 7.

FIG. 8 further illustrates that a closing document generation request will be sent to the software system in step 8 of the flow chart. This request can automatically populate the documents and allow the documents to be printed from a web browser, remote client, or other viewer as in step 9. If the data for the documents change, then the data changes (i.e. loan changes) can be entered into the mortgage software system and the documents can be re-populated and re-printed. Once all of the prior to funding conditions have been fulfilled and checked off electronically, then the mortgage loan can be funded as in step 10.

In one example embodiment, the mortgage software system may employ individual modules that are designed to be driven by a common software engine. Each component handles a specific function and may easily be changed. For instance, a component for 30-year fixed interest rates for a specific loan product can be changed at any time and the engine would continue to recognize the component and its relationship to the rest of the software. The advantage of this architecture is that changing loan programs, rates, underwriting criteria, or literally any part of the lending programs can be done without rewriting any major portion of the software package. This flexibility can be a competitive advantage in the highly volatile mortgage lending market.

Another embodiment of the software includes a lead generation system that simplifies lead generation tasks with scripted functions. These scripted functions include lead generation and lead follow-up. The loan application can also use scripted screens that are provided for the user or mortgage originator. Other important functions may include a script for credit report analysis done with the borrower, loan selection with the borrower, and a signature interview when the borrower signs loan documents.

The present system and method for loan management incorporates a large portion of the functions use in the mortgage business into a single software package. Other functions that have been included are a scalable database, along with a comparatively fast and accurate application, a loan processing system, and loan closing system. A complete loan origination system can be included. Because all of the data information is centralized this provides immediate communication and corroboration between a loan officer, borrower, loan processor, or others.

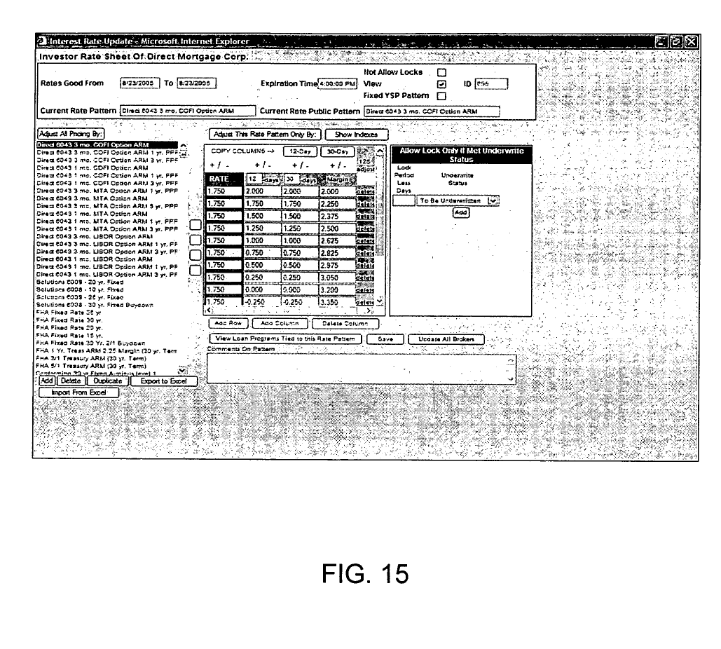

A high level of customization is available with the present system and method. FIG. 15 illustrates an example of a portion of the mortgage software where a mortgage broker banker can set the rebate rates that are based on the current day's interest rate pricing made available by the mortgage loan system. In addition, the mortgage broker can set overrides on the interest rate for special customers or employees. More complex cost patterns may be used in the mortgage software system if desired. Alternatively, a simplified cost pattern can be used where appropriate.

There are direct measurable results that are produced by the present software system and method. One result is that the mortgage application and approval process may take less than an hour (not many days as in the past). In some situations, the loan approval process for multiple loan products may only take a few minutes

Another result is that the centralized system can retrieve and display accurate, critical information at the very moment the information is needed. This accurate information can provide accurate underwriting which results in low loan fall-out rates. In other words, a mortgage banker is able to sell nearly all of its underwritten loans to correspondent lenders because the loans are more accurately and completely underwritten. Loan accuracy avoids discounting a loan to a correspondent leader in order to sell it.

The mortgage software system can also provide lower-cost business growth and expansion for brokers and mortgage bankers because fewer staff members are hired to perform the same amount of loan processing and underwriting. Since the present system and method is computer network-based, this allows users to work from home or at the borrower's desired location. In one embodiment, the software can be accessible entirely over the internet using a web browser or similar viewing program. This software networkability allows loan information to be more easily available to mortgage professionals and borrowers.

Remote processing capabilities allow the mortgage broker to bring the mortgage application process directly to the borrower using wireless internet and similar capabilities. Office overhead can be reduced because less may be spent on rent and equipment maintenance. In addition, the system may be continuously accessible to the mortgage broker, borrower, and loan officer using secure logins. A centralized system also lets the users or mortgage brokers use learn one software system and not 11 or more different and unrelated systems.

The embodiment of the mortgage software system and methods described herein can deliver a loan package from the initial quotes that go to the mortgage broker after an application is submitted to a mortgage banker through loan closing documents and secondary market documents. This delivery all happens seamlessly.

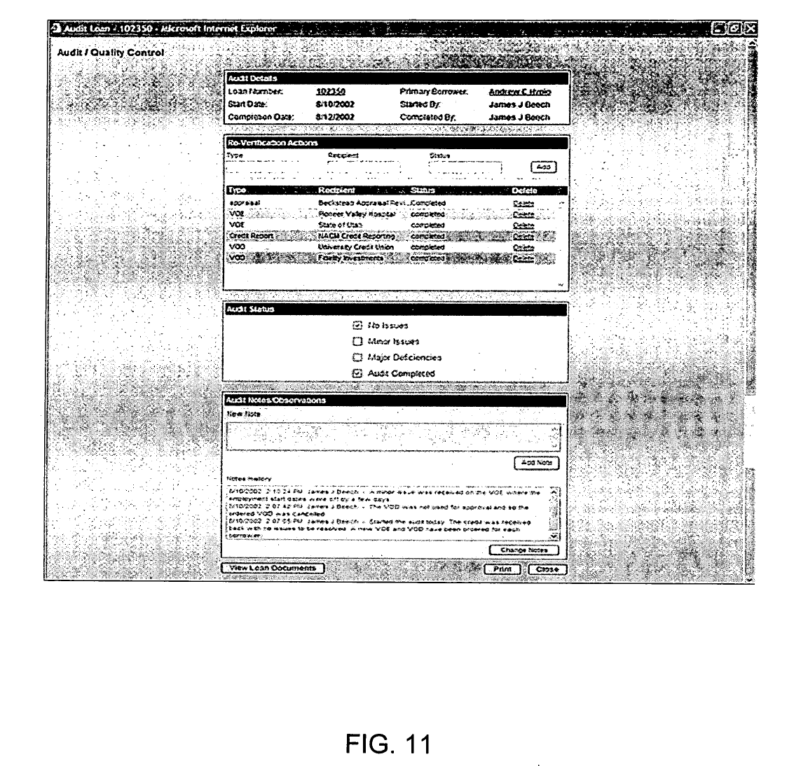

Quality control for loans is also improved and speeded up. Supervisors for the system are able to view all loans from the time the loans are being originated. For example, all supervisors can view the same home buyer and their loan status at the same time. In addition, quality control measures and reviews can be applied before funding and before closing. These quality control measures can be implemented by a human review, by automated business rules, or a combination of both. This avoids guessing whether the file is complete as has occurred so often with paper files. FIG. 11 depicts an example of such an electronic audit interface.

In summary, benefits are provided by the present software system and method where mortgage brokers have access to loan products which would otherwise not be known to the mortgage broker software presenting the loan products. In addition, the loan officers and processors may rely on the mortgage software system to close loans and their not their experience or limited training. Further, users are guided with detailed sales scripts integrated into pre-designed industry-used loan origination forms.

The flexibility and power of the mortgage software system enables the immediate introduction of any new loan products available in the market. Borrowers are then immediately able to compare an approval for new products with approvals they receive for older types of products. A strong ability to deliver new products and services provides a competitive advantage in the marketplace. For example, the mortgage company can even provide property insurance or other additional products, in addition to the loans.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for qualifying and selecting a mortgage loan for a borrower, comprising the steps of:
collecting mortgage loan information from the borrower;
obtaining credit information for the borrower via a network based on the mortgage loan information;
comparing combined mortgage loan information and credit information with conditions of a plurality of mortgage loan programs offered by a mortgage supplier;
generating a qualified active listing of mortgage loan programs from a plurality of mortgage loan programs, wherein the qualified active listing includes mortgage loan programs for which a borrower has been approved; and
selecting a mortgage loan program that a borrower desires to purchase.

2. A method as in claim 1, wherein the step of generating a qualified active listing of mortgage loan programs further comprises the step of listing mortgage loan programs that conform to mortgage loan program conditions as compared to the mortgage loan information and credit information obtained for the borrower.

3. A method as in claim 1, further comprising the step of grouping the approved loan programs under a defined heading.

4. A method as in claim 1, further comprising the step of grouping the approved loan programs under the defined heading further comprises the step of grouping approved loan programs under the approved loan program heading and suggested loan programs under a suggested loans heading.

5. A method as in claim 1, further comprising the step of generating a listing of referred mortgage loans that are not approved for the borrower and detailed reasons why the borrower was not approved for the mortgage loan programs.

6. A method as in claim 1, further comprising the step of generating an electronic mortgage checklist based on the mortgage program that has been selected by a borrower.

7. A method as in claim 6, further comprising the step of providing the electronic mortgage underwriting checklist with conditions that are not modifiable by an underwriter.

8. A method as in claim 1, wherein the step of collecting mortgage loan information from a borrower further comprises the step of collecting a borrower's name, social security number and address of a desired real estate purchase.

9. A method as in claim 1, further comprising the step of generating a qualified active listing of mortgage loan programs, using loan approval conditions selected from the group consisting of maximum loan/minimum appraisal, specific loan amount/minimum appraisal, user defined purchase price and loan amount, a selected loan program and advanced approval.

10. A method as in claim 1, wherein the step of collecting mortgage loan information further comprises the step of collecting mortgage information input by a user selected from the group consisting of the borrower's name, the borrower's social security number, the mortgage property address, and a fixed interest or adjustable rate mortgage selection, loan term, amortization term, agency, a loan margin, mortgage insurance criteria, wherein the list of approved mortgages is generated based on the mortgage information input by the user.

11. A method as in claim 1, wherein the step of obtaining credit information electronically across a network based on the mortgage loan information further comprises the step of electronically retrieving employment information.

12. A method for underwriting a mortgage loan for a potential borrower, comprising the steps of:
collecting mortgage loan application information from the potential borrower;
obtaining credit information electronically based on the mortgage loan application information;
comparing the combined mortgage loan application information and credit information with conditions of a plurality of mortgage loans offered by a mortgage program supplier;
generating a listing of approved mortgage programs based on the mortgage loan application information and credit information provided;
allowing a mortgage officer to select the mortgage that a borrower desires to participate in; and
initiating an underwriting process using the selected a mortgage program.

13. A method as in claim 12, further comprising the step of populating an underwriting checklist for a mortgage underwriter based on the mortgage program selected.

14. A method as in claim 12, further comprising the step of restricting access to the underwriting checklist so that a mortgage underwriter cannot change conditions in the underwriting checklist.

15. A method as in claim 12, further comprising the step of linking a plurality of unambiguous mortgage conditions to a selected mortgage program.

16. A method as in claim 12, further comprising the step of generating loan closing documents based on the loan program selected and underwriting performed.

17. A method as in claim 16, further comprising the step of loading mortgage loan data directly into electronic loan disclosure and closing documents.

18. A system for underwriting and selecting a mortgage loan for a borrower, comprising:
a loan data collection module configured to collect mortgage loan information from the borrower;
a third party data retrieval module configured to retrieve credit information via a network based on the mortgage loan information;
an active listing loan engine configured for comparing combined mortgage loan information and credit information with conditions for a plurality of mortgage loan programs offered by a mortgage supplier;
a qualified active listing of mortgage loan programs from a plurality of mortgage loan programs stored in a database, the qualified active listing including the mortgage loan programs for which a borrower conforms to mortgage loan program criteria based on the mortgage application information and credit information provided for the borrower; and
a loan listing interface configured to enable a mortgage officer to select a mortgage loan program from the qualified active listing that a borrower desires to purchase.

19. A system as in claim 18, further comprising mortgage listings divided into the groups comprising: accepted loan programs, referred loan programs, suggested loan programs and loan programs not checked for qualification.

20. A method for identifying and underwriting mortgage loans for a borrower, comprising the steps of:
collecting mortgage loan information from the borrower;
obtaining credit history via a network based on the mortgage loan information;
activating a single user interface command to initiate the assembly of a qualified active listing of mortgage programs for loan qualification;
generating the qualified active listing of mortgage loan programs by comparing a plurality of mortgage loan programs stored in a database against borrower information and credit history;
enabling a mortgage officer to select a mortgage loan program that a borrower desires to use; and
clearing the loan conditions of the mortgage that was selected by the borrower.

21. A method as in claim 20, further comprising the step of closing the loan using closing documents generated automatically based on a qualified loan selected by the borrower.
